(19) United States
(12) Patent Application Publication
(10) Pub. No.: US 2026/0264051 A1
(43) Pub. Date: Sep. 10, 2026

(54) HIGH-ENTROPY PEROVSKITE-BASED CATALYST MATERIAL AND DIRECT AMMONIA PROTON CONDUCTIVE FUEL CELL APPLIED THEREWITH

(71) Applicant: KOREA ADVANCED INSTITUTE OF SCIENCE AND TECHNOLOGY, Daejeon (KR)

(72) Inventors: Kang Taek LEE, Daejeon (KR); Joong Myeon BAE, Daejeon (KR); Dong Yeon KIM, Daejeon (KR); Kang Yong LEE, Daejeon (KR); Se Eun OH, Daejeon (KR); Hyeong Geun KIM, Daejeon (KR); Min Cheol LEE, Suwon-si (KR)

(21) Appl. No.: 19/197,490

(22) Filed: May 2, 2025

(30) Foreign Application Priority Data
Mar. 6, 2025 (KR) 10-2025-0028845

(51) Int. Cl. B01J 23/00; B01J 23/72; B01J 23/745; B01J 23/755; B01J 35/70

(52) U.S. Cl. CPC B01J 23/002; B01J 23/72; B01J 23/745; B01J 23/755; B01J 35/735; B01J 2235/15

(57) ABSTRACT

An embodiment is related to a high-entropy perovskite oxide as an ammonia catalyst layer material for improving the performance and stability of NH3-PCFC and a high-performance/high-stability NH3-PCFC applied therewith, and provides a high-entropy perovskite oxide-based catalyst material, wherein in a perovskite oxide including strontium (Sr), iron (Fe), molybdenum (Mo), manganese (Mn), chromium (Cr), copper (Cu), and nickel (Ni), nano alloy particles are eluted onto the surface of the perovskite oxide in a reducing atmosphere.

### CROSS-REFERENCE TO RELATED APPLICATIONS

This application claims priority from Korean Patent Application No. 10-2025-0028845, filed on Mar. 6, 2025, in the Korean Intellectual Property Office, which is incorporated herein by reference in its entirety.

### BACKGROUND

The disclosure relates to a high-entropy perovskite-based catalyst material and a direct ammonia proton conductive fuel cell applied therewith, and more specifically, to a high-entropy perovskite oxide as an ammonia catalyst layer material for improving the performance and stability of NH₃—PCFC, and a high-performance/high-stability NH₃—PCFC applied therewith.

Ammonia (NH₃) is attracting attention as a fuel for proton conductive fuel cells (PCFCs) due to its carbon-free characteristics, high hydrogen content, excellent volumetric energy density, and low flammability.

As a hydrogen carrier with high energy density, ammonia provides a cleaner and more cost-effective alternative to existing hydrocarbon-based fuels, and is considered a practical option for the future hydrogen economy due to its ease of large-scale storage and transportation.

In particular, direct ammonia PCFC (NH₃—PCFC) that directly utilizes ammonia in PCFCs has the advantage of simplifying system design, improving energy efficiency, and reducing overall costs because it does not require an external ammonia decomposition reactor.

In solid oxide fuel cells (SOFCs) that use oxygen ion-conducting electrolytes, when ammonia is used as a fuel, oxygen ions are likely to react with ammonia as they move between electrodes to generate NOₓ.

On the other hand, NH₃—PCFC use protons as the main charge carriers and do not induce NOₓ-generating reactions. These characteristics make NH3-PCFC an environmentally friendly alternative for clean energy conversion.

However, NH3-PCFC faces several technical challenges that limit its practical application potential. The biggest limitation is the lack of catalytic activity of the fuel electrode for ammonia decomposition.

Nickel-based fuel electrodes, which are widely used in existing PCFCs, have limited performance as NH₃ decomposition catalysts. Nickel has problems such as particle agglomeration, sintering, and nitrification when operated for a long time in a high-concentration ammonia environment, which reduces catalytic activity and fuel cell performance.

Research has been proposed to add an ammonia decomposition catalyst layer to the fuel electrode to improve stability and performance, but the catalytic performance and stability have not been sufficiently secured, so the development of a material with high activity and durability is required.

### SUMMARY

An aspect of the disclosure is to provide a high-entropy perovskite oxide as an ammonia catalyst layer material for improving the performance and stability of NH₃—PCFC and a high-performance/high-stability NH₃—PCFC applied therewith.

The aspect of the disclosure is not limited to that mentioned above, and other aspects not mentioned will be clearly understood by those skilled in the art from the description below.

An embodiment of the disclosure provides a high-entropy perovskite oxide-based catalyst material.

The high-entropy perovskite oxide-based catalyst material according to an embodiment of the disclosure may be
a high-entropy perovskite oxide-based catalyst material, wherein in a perovskite oxide including strontium (Sr), iron (Fe), molybdenum (Mo), manganese (Mn), chromium (Cr), copper (Cu), and nickel (Ni), nano alloy particles are eluted onto the surface of the perovskite oxide in a reducing atmosphere.

In addition, according to an embodiment of the disclosure, the perovskite oxide may be represented by chemical formula 1.

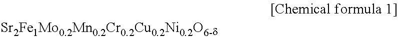

in chemical formula 1, 6 has a value of 0 to 0.5.

In addition, according to an embodiment of the disclosure, the nano alloy particles may be nano particles having an average diameter size of 10 nm to 30 nm.

In addition, according to an embodiment of the disclosure, the nano alloy particles may be a ternary alloy composed of Ni, Fe, and Cu.

In addition, according to an embodiment of the disclosure, the nano alloy particles, while being eluted onto the surface of the perovskite oxide and fixed on the surface of the perovskite oxide, may be uniformly distributed over the entire surface of the perovskite oxide.

Another embodiment of the disclosure provides a method for producing high-entropy perovskite oxide-based catalyst material.

The method for producing high-entropy perovskite oxide-based catalyst material according to an embodiment of the disclosure may include:
providing a mixed solution comprising a high-entropy perovskite precursor; forming a uniform sol with the mixed solution; drying the sol to form a gel; pre-calcining the gel to form ash; and calcining the ash to obtain a high-entropy perovskite powder.

In addition, according to an embodiment of the disclosure, in the providing of the mixed solution, the high-entropy perovskite precursor may include a strontium (Sr) source, an iron (Fe) source, a molybdenum (Mo) source, a manganese (Mn) source, a chromium (Cr) source, a copper (Cu) source, and a nickel (Ni) source.

In addition, according to an embodiment of the disclosure, the forming of the sol may include: adding citric acid and ethylenediaminetetraacetic acid (EDTA) to the mixed solution; and adjusting pH to about 7 to 9 with an ammonia aqueous solution.

In addition, according to an embodiment of the disclosure, the forming of the uniform gel may be performed by drying the sol at 80° C. to 100° C.

In addition, according to an embodiment of the disclosure, in the pre-calcining, heating may be performed in a temperature range of 300° C. to 400° C.

In addition, according to an embodiment of the disclosure, the calcining may be performed in a temperature range of 1,000° C. to 1,100° C.

Another embodiment of the disclosure provides a direct ammonia proton conductive fuel cell (NH₃—PCFC).

The direct ammonia proton conductive fuel cell (NH₃—PCFC) according to an embodiment of the disclosure may include:
a fuel electrode; a catalyst layer positioned on the fuel electrode; a proton conductive electrolyte layer positioned on the catalyst layer; and an air electrode positioned on the proton conductive electrolyte layer,
wherein the catalyst layer includes the above-described high-entropy perovskite-based catalyst material.

In addition, according to an embodiment of the disclosure, the fuel electrode may be composed of a fuel electrode support and a functional layer, and include a composite of NiO and BaZr_{0.4}Ce_{0.4}Y_{0.1}Yb_{0.1}O_{3-δ} (BZCYYb, where δ is a value of 0 to 0.5).

In addition, according to an embodiment of the disclosure, the proton conductive electrolyte layer may include BaZr_{0.4}Ce_{0.4}Y_{0.1}Yb_{0.1}O_{3-δ} (BZCYYb, where δ is a value of 0 to 0.5).

According to an embodiment of the disclosure, it is possible to provide a high-entropy perovskite oxide for an ammonia catalyst layer material for improving the performance and stability of NH₃—PCFC and a high-performance/high-stability NH₃—PCFC applied therewith.

According to one embodiment of the disclosure, it is possible to provide a catalyst layer having stability, wherein a ternary alloy is dissolved in real time on the surface of a high-entropy oxide having high stability, thereby maximizing ammonia decomposition performance.

In addition, according to an embodiment of the disclosure, there is an economic advantage because precious metal materials (Ru, Pt, Pd, etc.) that were mainly used as ammonia catalyst materials in the past are not used.

In addition, an NH₃—PCFC to which a catalyst according to an embodiment of the disclosure is applied not only exhibits higher NH3 conversion performance than existing oxide materials and fuel electrode materials, but also has higher performance and stability compared to a cell to which the catalyst layer is not applied.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B, and 1C are images showing X-ray diffraction patterns of SFM, SFMMCCN powder after calcination and SFMMCCN according to temperature in a reducing atmosphere;

FIGS. 2A, 2B, and 2C are images showing the microstructure and the distribution of dissolved particles of SFMMCCN before and after reduction;

FIGS. 3A, 3B, 3C, 3D, 3E, 3F, 3G, 3H, 3I, and 3J are images showing the results of the atomic unit microstructure and chemical composition analysis of SFMMCCN after reduction treatment;

FIG. 4 is a graph showing the decomposition rate of Ni—BZCYYb, a fuel electrode material, low-entropy SFM, and high-entropy material SFMMCCN for ammonia;

FIG. 5 is a graph showing the results of the catalytic stability evaluation of a Ni—BZCYYb material and an SFMMCCN material;

FIGS. 6A, 6B, and 6C are images showing the results of the cross-sectional microstructure analysis of NH₃—PCFC to which a catalyst layer is applied according to an embodiment of the disclosure;

FIGS. 7A, 7B, and 7C are graphs showing the electrochemical performance results for a unit cell (SFMMCCN ACL) to which a catalyst layer is applied according to an embodiment of the disclosure and a unit cell (Bare cell) to which the catalyst layer is not applied; and

FIG. 8 is a graph showing the stability results for a unit cell (SFMMCCN ACL) to which a catalyst layer according to an embodiment of the disclosure is applied and a unit cell (Bare cell) to which the catalyst layer is not applied.

### DETAILED DESCRIPTION

Hereinafter, the disclosure will be described with reference to the accompanying drawings. However, the disclosure may be implemented in various different forms and therefore is not limited to the embodiments described herein, but should be understood to include all modifications, equivalents, or substitutes included in the spirit and technical scope of the disclosure.

In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between.

In addition, when a part such as a layer, film, region, or plate is said to be “on” another part, this includes not only the case where it is “directly on” another part, but also the case where there is another part in between. In addition, in this specification, when a part such as a layer, film, region, or plate is formed on another part, the direction in which it is formed is not limited to the upper direction, and includes being formed in the side or lower direction. On the other hand, when a part such as a layer, film, region, or plate is said to be “under” another part, this includes not only the case where it is “directly under” another part, but also the case where there is another part in between.

In this specification, the terms “upper surface” and “lower surface” are used as relative concepts in order to easily explain the technical idea of the disclosure. Therefore, the terms “upper surface” and “lower surface” do not refer to a specific direction, position, or component, and are interchangeable with each other.

For example, the “upper surface” may be interpreted as the “lower surface,” and the “lower surface” may be interpreted as the “upper surface.” Therefore, the “upper surface” may be expressed as “first” and the “lower surface” may be expressed as “second”, or the “lower surface” may be expressed as “first” and the “upper surface” may be expressed as “second”. However, within one embodiment, the terms “upper surface” and “lower surface” are not used interchangeably.

Unless otherwise defined, all terms used herein, including technical or scientific terms, have the same meaning as generally understood by a person of ordinary skill in the art to which the disclosure belongs. Terms defined in commonly used dictionaries should be interpreted as having a meaning consistent with the meaning they have in the context of the relevant technology, and shall not be interpreted in an ideal or overly formal sense unless explicitly defined in this application.

In addition, when a part is said to “include” a certain component, this does not exclude other components unless specifically stated to the contrary, but rather means that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

Hereinafter, embodiments of the disclosure will be described in detail with reference to the accompanying drawings.

### a High-Entropy Perovskite Oxide-Based Catalyst Material According to an Embodiment of the Disclosure Will be Described.

As an example of the embodiment, there may be a high-entropy perovskite oxide-based catalyst material, wherein in a perovskite oxide including strontium (Sr), iron (Fe), molybdenum (Mo), manganese (Mn), chromium (Cr), copper (Cu), and nickel (Ni),
nano alloy particles are eluted onto the surface of the perovskite oxide in a reducing atmosphere.

As described above, the composition of the nano alloy particles eluted onto the surface of the perovskite oxide corresponds to one of the main core compositions of the disclosure,
and through the composition, the effect of maximizing ammonia decomposition performance and simultaneously having stability can be obtained.

At this time, the perovskite oxide may be expressed by chemical formula 1.

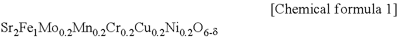

in chemical formula 1, 6 has a value of 0 to 0.5.

At this time, the nano alloy particles may be nano particles having an average diameter size of 10 nm to 30 nm, and
the nano alloy particles may be small and uniformly distributed in the range of 10 nm to 30 nm as described above, thereby obtaining the effect of expanding the active site capable of promoting the decomposition of ammonia.

In addition, the nano alloy particles may be a ternary alloy composed of Ni, Fe, and Cu.

When the nano alloy particles are a ternary alloy of Ni—Fe—Cu, there is an excellent effect on ammonia catalytic activity due to advantages in ammonia adsorption and decomposition, such as optimized adsorption energy for NH3 and improved N₂ desorption rate compared to a single catalyst.

At this time, the nano alloy particles, while being eluted onto the surface of the perovskite oxide and fixed to the surface of the perovskite oxide, are uniformly distributed over the entire surface of the perovskite oxide.

More specifically, when the high-entropy perovskite oxide proposed in the disclosure is heated in a reducing atmosphere (such as hydrogen or H₂-containing mixed gas),
metal ions (Ni, Fe, Cu) substituted in the B-site are partially reduced and escape the parent lattice and are eluted to the surface, thereby forming nano-alloy particles (Ni—Fe—Cu alloy phase).

At this time, the metal particles formed on the surface share an interface with the parent perovskite oxide, which means that the nano-particles are not simply attached to the surface but are anchored in a form that grows from the inside.

According to the results of electron microscope (e.g., SEM, TEM) observation, the diffraction pattern of the metal phase and the nano-particles that were not observed before reduction are confirmed to be uniformly distributed on the surface after high-temperature reduction.

Nano alloy particles formed through this dissolution phenomenon are observed in the form of particles with an average diameter of approximately 10 to 30 nm, and can maintain long-term thermal/chemical stability by forming a single interface with the parent oxide.

In particular, due to the interface pinning effect, the nano metal particles formed on the surface are not easily sintered or detached at high temperatures.

In general, catalyst particles applied through a separate deposition process have a problem in that the particles become agglomerated with each other during high-temperature heat treatment or long-term operation, and the particle size increases, or the particles are peeled off and separated from the surface, thereby reducing the catalytic activity.

On the other hand, the nano alloy particles according to the disclosure form a structure in which some thereof are connected to the parent lattice, so that the rearrangement or serious agglomeration of the metal particles can be limited.

As a result, the durability is improved, and the ammonia decomposition catalytic activity can be stably maintained even during a long-term operation period.

In addition, the nano alloy particles are a ternary alloy in which the metal elements of Ni, Fe, and Cu are alloyed, and exhibit high reaction activity and excellent selectivity in a wider temperature range than single metal catalysts.

In fact, the results of comparing the ammonia decomposition reaction rates before and after reduction show that the perovskite with the eluted nano alloy particles exhibits superior ammonia decomposition rates and long-term stability compared to existing catalysts.

As a result, the high-entropy perovskite material proposed in the disclosure and the nano alloy particles formed therefrom induce eluted in a reducing atmosphere, thereby enabling the use of the metal alloy nanoparticles fixed on the surface as a catalyst, and when introduced to a direct ammonia proton conductive fuel cell (NH3-PCFC) or other ammonia fuel conversion systems, it is possible to simultaneously secure excellent catalytic performance and durability over a long period of time.

### a Method for Producing a High-Entropy Perovskite Oxide-Based Catalyst Material According to Another Embodiment of the Disclosure Will be Described.

The method for producing the above high-entropy perovskite oxide-based catalyst material is an invention of a different category having substantially the same technical composition as the above-described high-entropy perovskite oxide-based catalyst material,
so the above-described content may be applied as is when explaining the above high-entropy perovskite oxide-based catalyst material.

As an example of the embodiment, there may be a method for producing a high-entropy perovskite oxide-based catalyst material, including: providing a mixed solution including a high-entropy perovskite precursor; forming a uniform sol with the mixed solution; drying the sol to form a gel; pre-calcining the gel to form ash; and calcining the ash to obtain a high-entropy perovskite powder.

The mixed solution may be prepared by dissolving a high-entropy perovskite precursor in distilled water.

In addition, in the producing of the mixed solution, the high-entropy perovskite precursor may include a strontium (Sr) source, an iron (Fe) source, a molybdenum (Mo) source, a manganese (Mn) source, a chromium (Cr) source, a copper (Cu) source, and a nickel (Ni) source.

More specifically,
the strontium source may be strontium nitrate (Sr(NO₃)₃),
the iron source may be iron nitrate (Fe(NO₃)₃),
the molybdenum source may be ammonium molybdate ((NH₄)₆Mo₇O₂₄),
the manganese source may be manganese nitrate (Mn(NO₃)₂),
the chromium source may be chromium nitrate (Cr(NO₃)₃),
the copper source may be copper nitrate (Cu(NO₃)₂), and
the nickel source may be nickel nitrate (Ni(NO₃)₂).

In addition, the forming of the sol may include: adding citric acid and ethylenediaminetetraacetic acid (EDTA) to the mixed solution; and adjusting pH to about 7 to 9 with an ammonia aqueous solution.

As described above, when adding citric acid and ethylenediaminetetraacetic acid (EDTA), unlike when adding other chelating agents (e.g., acetylacetone), the effect of uniformly distributing metal ions in the solution and forming a stable sol can be obtained.

In addition, in the step above, adjusting the pH to about 7 to 9 with an ammonia aqueous solution is essential in that it optimizes the reactivity of the sol-gel process and uniformly maintains the precipitation or gel formation speed of metal ions.

In addition, the forming of the gel may be performed by drying the sol at 80° C. to 100° C., and
in particular, the performing may be in a temperature range for 22 to 26 hours.

In addition, in the pre-firing, heating may be performed in a temperature range of 300° C. to 400° C., and
in particular, the performing may be in a temperature range for 3 to 5 hours.

In the case of the calcining, if it is performed at an excessively low temperature of less than 300° C., there may be a problem in that residual organic matter may remain, and
on the other hand, if the above calcination step is performed at too high a temperature exceeding 400° C., there may be a problem in that rapid structural deformation may occur.

In addition, if the step above is performed too short, less than 3 hours, there may be a problem in that the reaction does not proceed sufficiently, making it difficult to form a uniform phase, and
on the other hand, if the step above is performed too long, more than 5 hours, there may be a problem in that excessive reaction may occur, increasing the possibility of forming an unnecessary secondary phase.

In addition, the calcining may be performed in a temperature range of 1,000° C. to 1,100° C.

The temperature range at which the calcining is performed is also important.

For example, if the calcining is performed at too low a temperature of less than 1,000° C., there may be a problem in that pure perovskite is not formed, and
on the other hand, if the calcining is performed at too high a temperature exceeding 1,100° C., there may be a problem in that an impurity phase is formed.

### A Direct Ammonia Proton Conductive Fuel Cell (NH₃—PCFC) According to Another Embodiment of the Disclosure Will be Described.

The direct ammonia proton conductive fuel cell (NH₃—PCFC) is an invention that includes substantially the same technical composition as the above-described high-entropy perovskite oxide-based catalyst material,
so the above-described content may be applied as is when explaining the above high-entropy perovskite oxide-based catalyst material.

As an example of the embodiment, there may be a direct ammonia proton conductive fuel cell (NH₃—PCFC) including: a fuel electrode; a catalyst layer positioned on the fuel electrode; a proton conductive electrolyte layer positioned on the catalyst layer; and an air electrode positioned on the proton conductive electrolyte layer,
wherein the catalyst layer may include the above-described high-entropy perovskite-based catalyst material.

At this time, the fuel electrode may be composed of a fuel electrode support and a functional layer, and
may include a composite of NiO and BaZr_{0.4}Ce_{0.4}Y_{0.1}Yb_{0.1}O_{3-δ} (BZCYYb, where δ is a value of 0 to 0.5).

In addition, the proton conductive electrolyte layer may include BaZr_{0.4}Ce_{0.4}Y_{0.1}Yb_{0.1}O_{3-δ} (BZCYYb, where δ is a value of 0 to 0.5).

### Producing Example 1. SFMMCCN(Sr₂Fe₁Mo_{0.2}Mn_{0.2}Cr_{0.2}Cu_{0.2}Ni_{0.2}O_{6-δ}) Synthesis

Sr₂Fe₁Mo_{0.2}Mn_{0.2}Cr_{0.2}Cu_{0.2}Ni_{0.2}O_{6-δ} (SFMMCCN) was produced through a sol-gel method.

Strontium nitrate (Sr(NO₃)₂), Iron nitratre (Fe(NO₃)₃), Amonium molybate ((NH₄)₆Mo₇O₂₄), Mangnese nitrate (Mn(NO₃)₂), Chromium nitrate (Cr(NO₃)₃), Copper nitrate (Cu(NO₃)₂), Nickel nitrate (Ni(NO₃)₂) were dissolved in DI water, and then citric acid and Ethylenediaminetetraacetic Acid (EDTA) were added.

Thereafter, the pH of the solution was adjusted to the range of 7 to 9 using an ammonia solution to produce a transparent solution.

The prepared solution was dried at 90° C. for 24 hours to obtain a gel.

The gel was reacted at 350° C. for 3 to 5 hours to obtain ash, and then calcined at 1050° C. to obtain final powder.

### Comparative Producing Example 1. SFM(Sr₂Fe_{1.5}Mo_{0.5}O_{6-δ}) Synthesis

The comparison group Sr₂Fe_{1.5}Mo_{0.5}O_{6-δ} (SFM) was also produced using the same process as producing example 1.

More specifically, Sr₂Fe_{1.5}Mo_{0.5}O_{6-δ} (SFM) was produced using a sol-gel method.

Strontium nitrate (Sr(NO₃)₂), Iron nitratre (Fe(NO₃)₃), Amonium molybate ((NH₄)₆Mo₇O₂₄) were dissolved in DI water, and then citric acid and ethylenediaminetetraacetic acid (EDTA) were added.

Thereafter, the pH of the solution was adjusted to the range of 7 to 9 using an ammonia solution to produce a transparent solution.

The prepared solution was dried at 90° C. for 24 hours to obtain a gel.

The gel was reacted at 350° C. for 3 to 5 hours to obtain ash, and then calcined at 1050° C. to obtain final powder.

### Producing Example 2. Direct Ammonia Proton Conductive Fuel Cell(NH3-PCFC) Manufacturing

The unit cell is manufactured using tape casting, screen printing, and brush coating techniques, and is composed of an ammonia catalyst layer, a fuel electrode support layer, a fuel electrode functional layer, an electrolyte layer, and an air electrode layer.

The slurry used to manufacture the tape of the fuel electrode support layer and the functional layer is composed of a composite of NiO and BaZr_{0.4}Ce_{0.4}Y_{0.1}Yb_{0.1}O_{3-δ} (BZCYYb).

An electrolyte slurry contains BZCYYb, and an air electrode slurry contains BaSc_{0.1}Ta_{0.1}Co_{0.8}O_{3-δ} (BSTC).

A catalyst slurry contains SFMMCCN.

Each slurry is manufactured using tape casting, and then sequentially laminated in layers while applying heat at 110° C. and then pressed.

The pressed tape is heated at 900° C. for 3 hours to remove organic substances.

Thereafter, a double-layer support composed of a fuel electrode/electrolyte is formed by sintering at 1300 to 1500° C. for 5 minutes using a microwave sintering device.

The fuel electrode layer of the sintered support is brush-coated with a catalyst layer slurry and then dried, and the air electrode slurry is screen-printed and coated on top of the electrolyte layer and then dried.

Thereafter, the final NH₃—PCFC unit cell is manufactured by sintering at 850° C. for 3 minutes using a microwave sintering furnace.

Before explaining experimental examples,
the experimental conditions of experimental examples below are as follows.

Powder XRD analysis was performed with an X-ray diffractometer (RIGAKU, SmartLab) in the 2θ range of 20° to 80° using Cu Kα radiation (λ=1.5418 Å).

A measured crystal structure was refined using HighScore software.

A microstructure of a unit cell was observed using scanning electron microscopy (SEM, Hitachi SU8230).

Atomic-level structural analysis was performed using transmission electron microscopy (TEM, Thermo Fisher Scientific Spectra Ultra).

In addition, the electrochemical characteristics of a unit cell were evaluated using a potentiostat (Bio-Logic, VMP-300). Measurements were conducted by supplying hydrogen (3% wet) to a fuel electrode and air (3% wet) to an air electrode, respectively.

In the evaluation using ammonia as fuel, ammonia (3% wet) was supplied to a fuel electrode and air under the same conditions was supplied to an air electrode to confirm the electrochemical characteristics.

Hereinafter, experimental examples will be described.

### Experimental Example 1. Crystallographic Phase Analysis of Catalyst Material

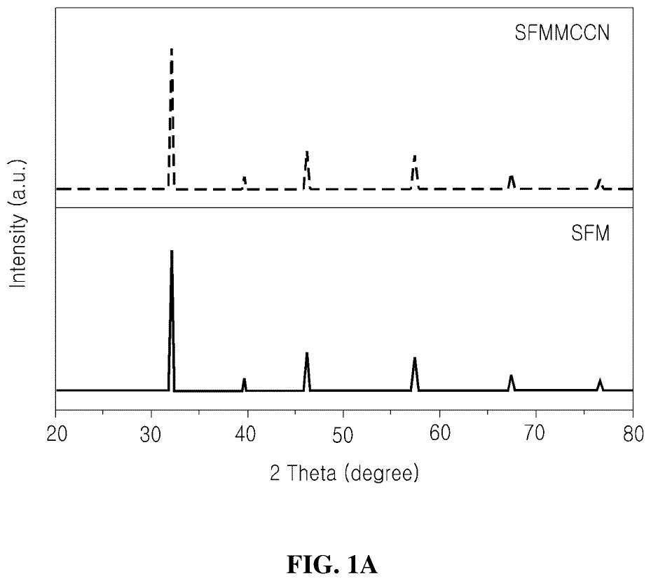

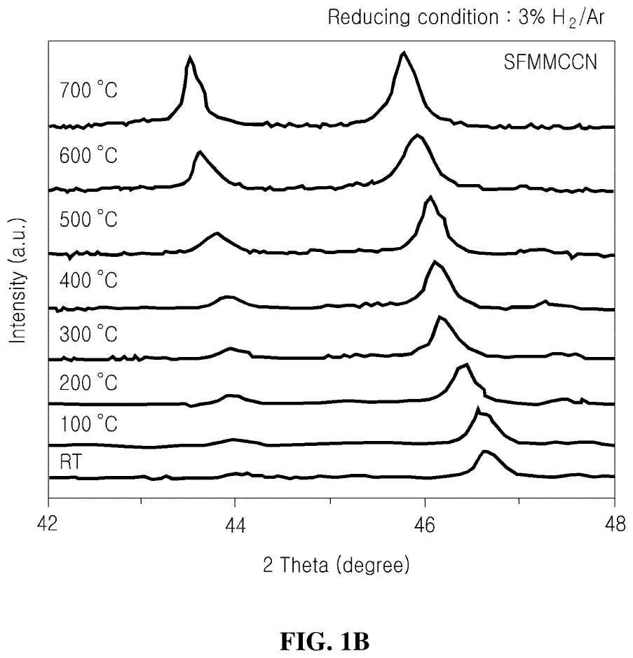

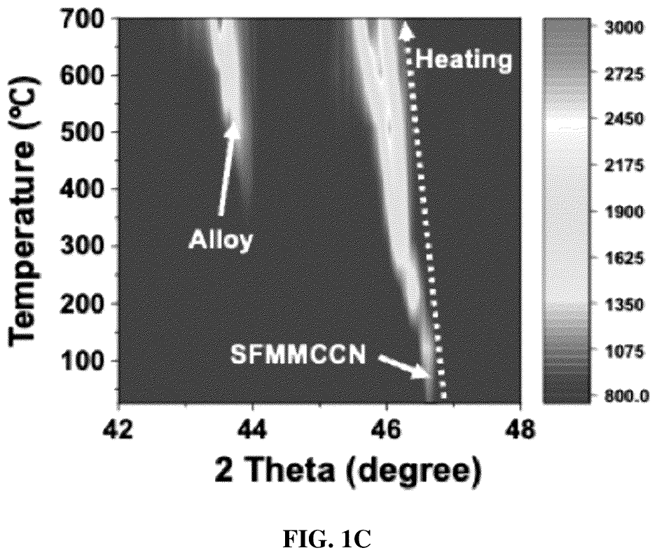

FIGS. 1A, 1i, and 1C are images showing X-ray diffraction patterns of SFM, SFMMCCN powder after calcination and SFMMCCN according to temperature in a reducing atmosphere.

Referring to FIGS. 1A, 1B, and 1C, it is possible to confirm that the high-entropy perovskite material, SFMMCCN, shows the same structure as SFM.

In addition, when in-situ temperature XRD analysis was performed in a reducing atmosphere, it is possible to confirm that a prominent alloy peak is formed around 400° C.

### Experimental Example 2. Microstructural Analysis of Catalyst Material

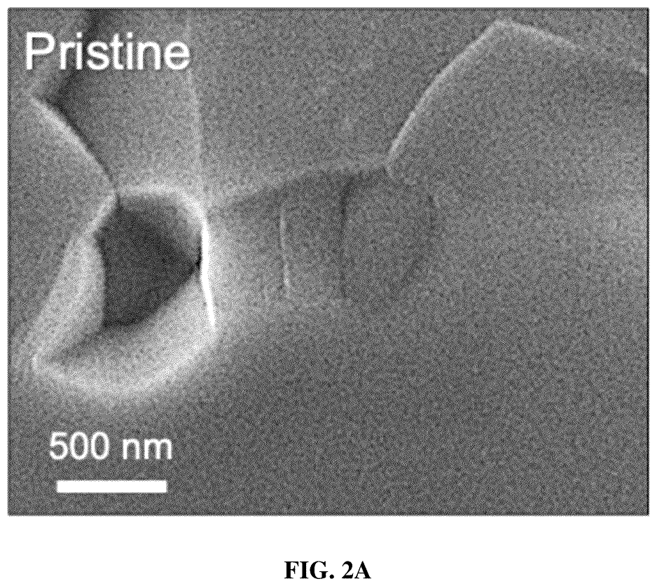

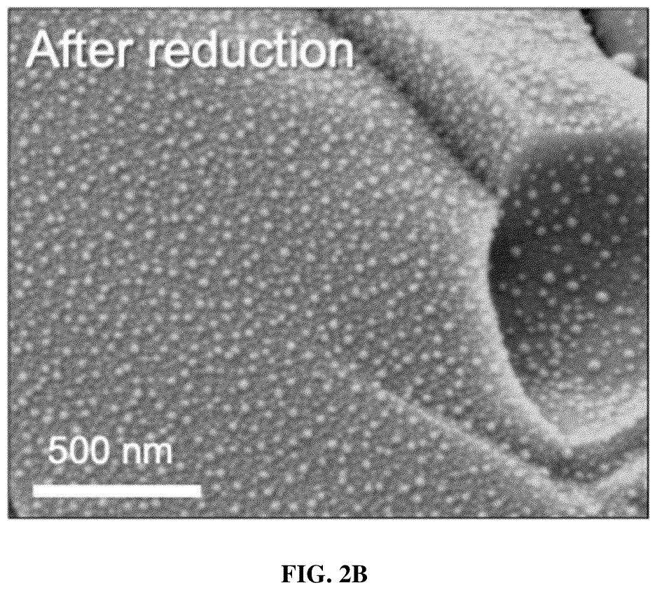

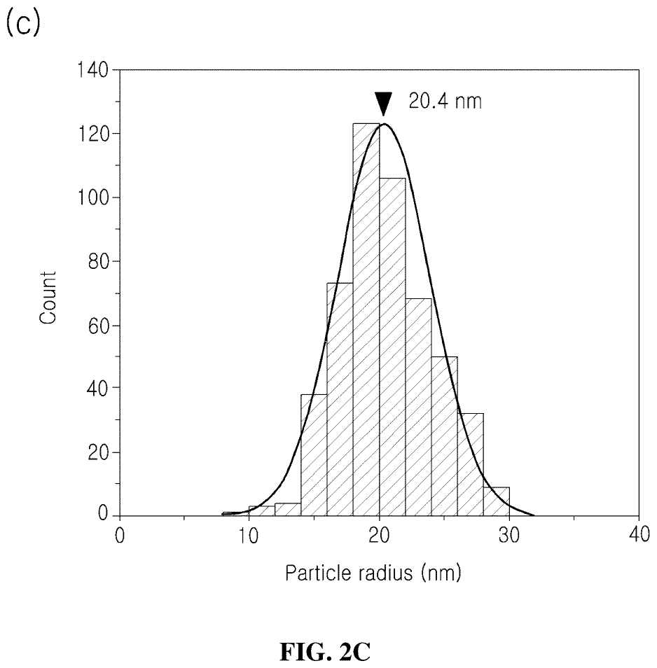

FIGS. 2A, 2B, and 2C are images showing the microstructure and the distribution of dissolved particles of SFMMCCN before and after reduction.

At this time, the reduction was carried out for 2 hours in a hydrogen atmosphere at 700° C.

Referring to FIGS. 2A, 2B, and 2C, after reduction, particles eluted on the surface were observed, and the particle size analysis results confirmed that nanoparticles eluted with an average size of 20 nm were observed.

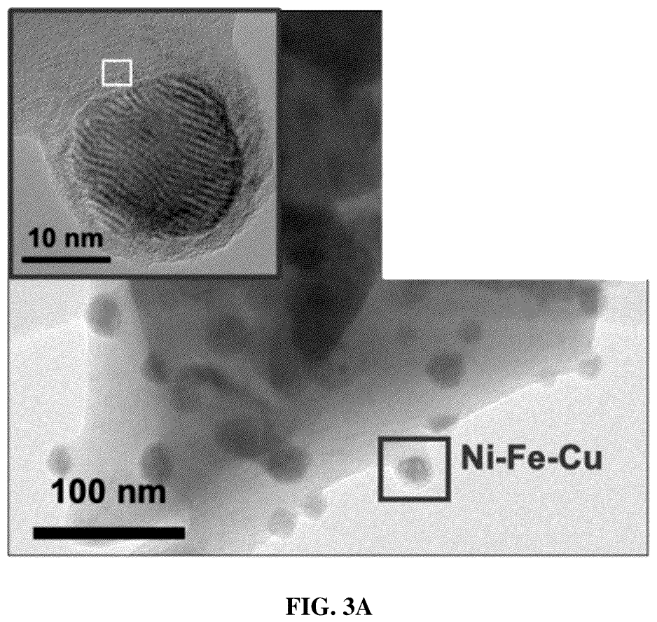

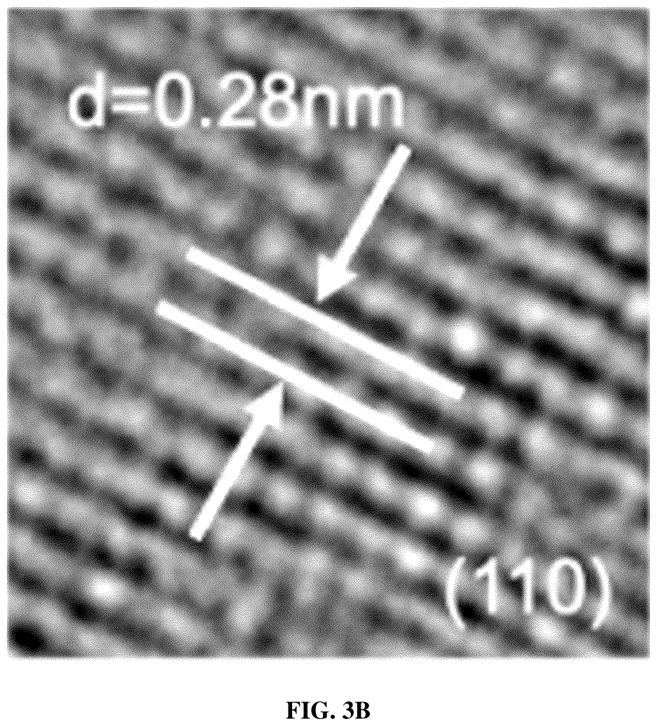

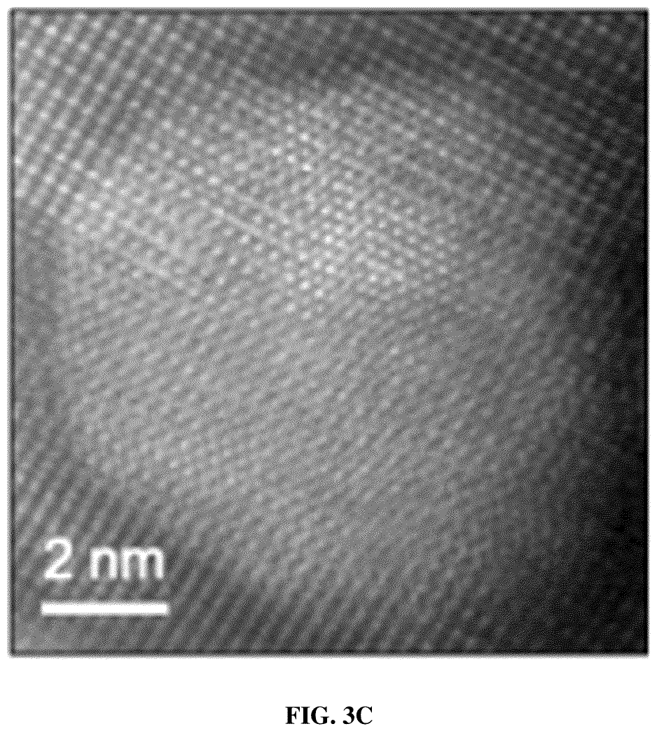

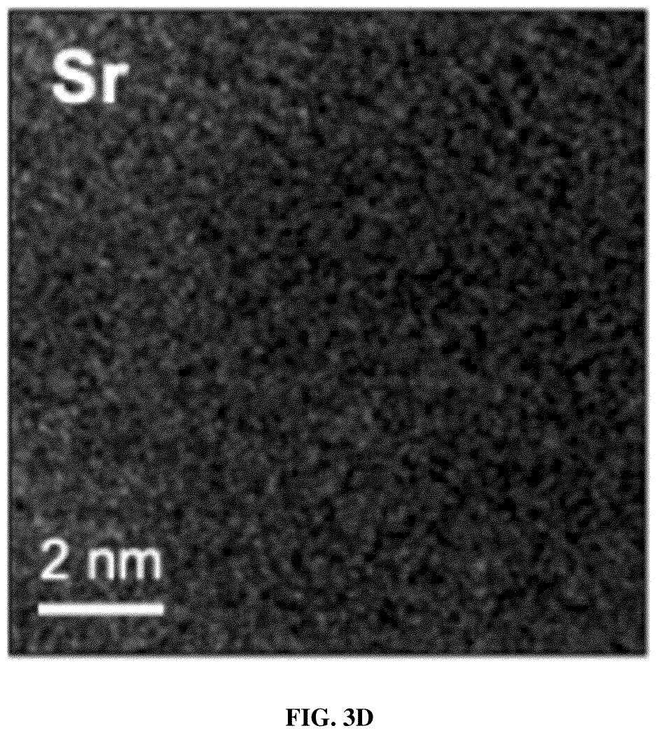

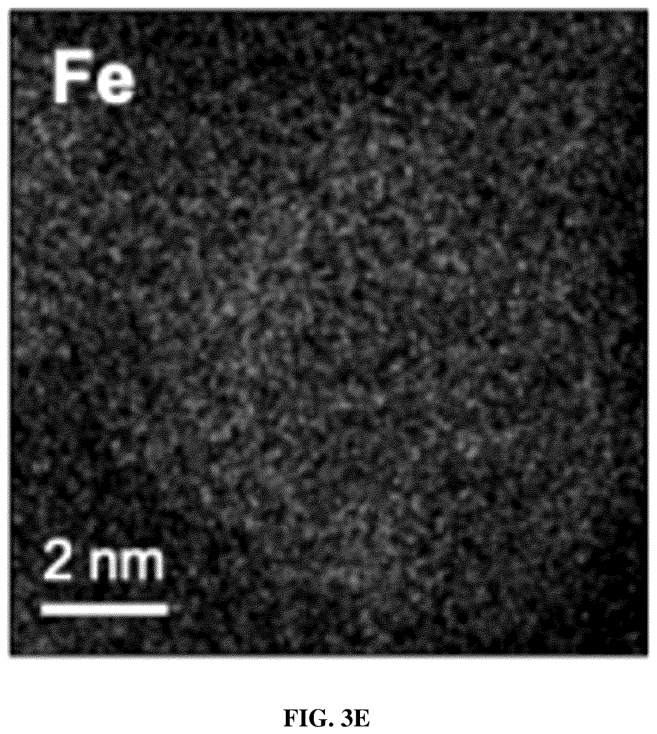

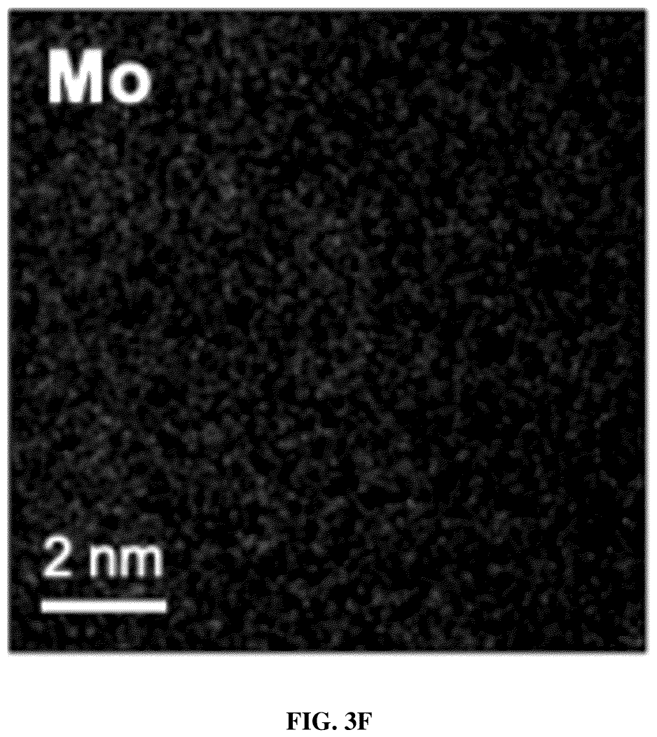

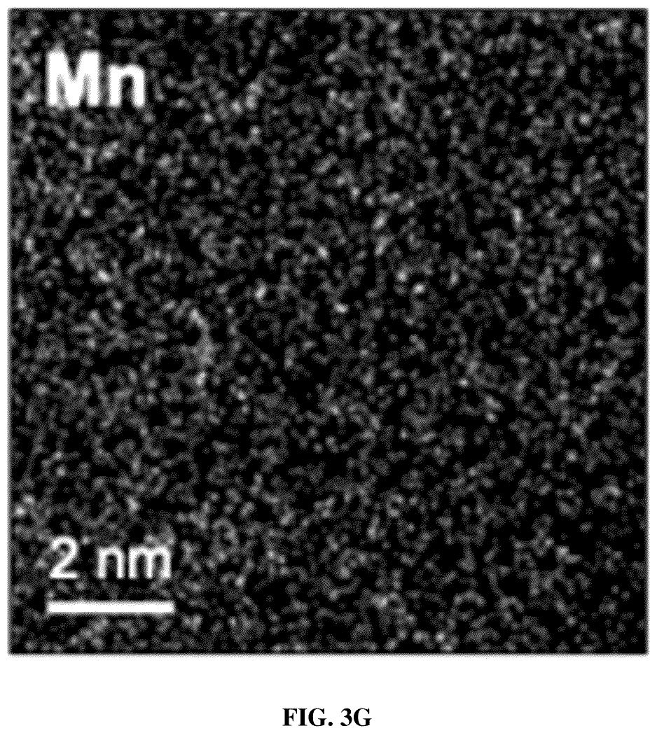

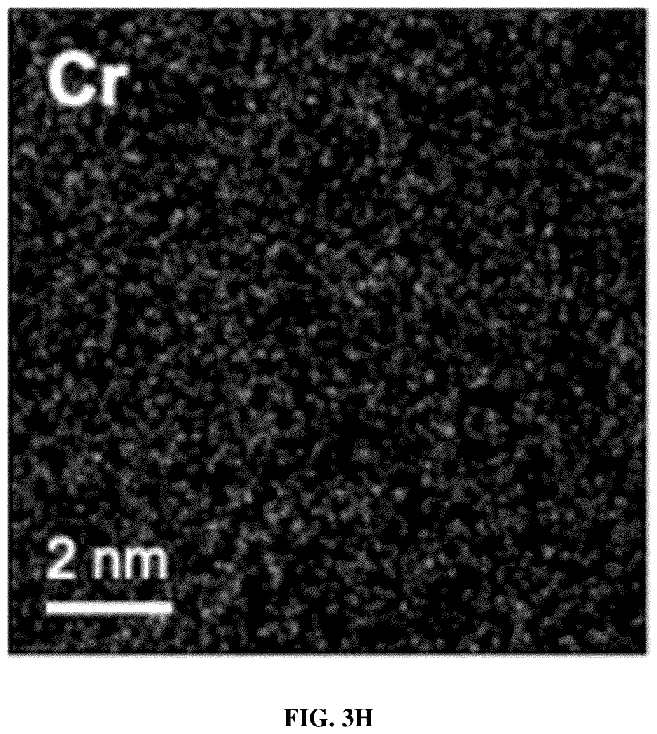

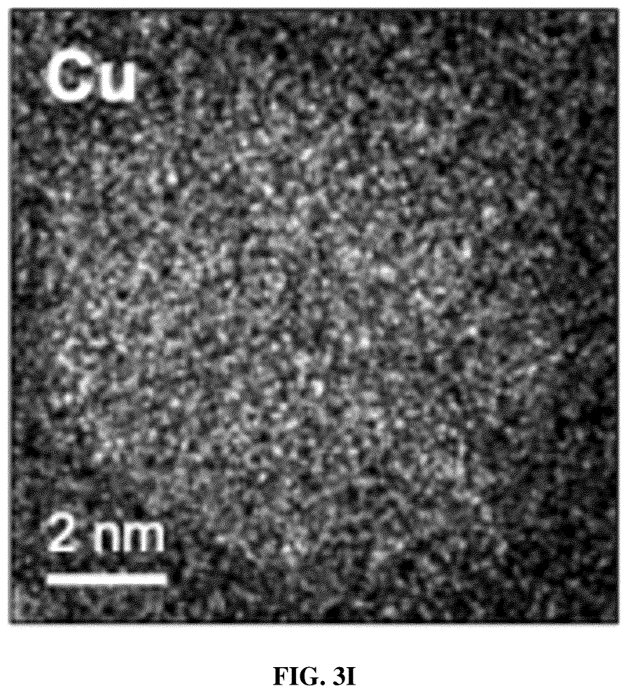

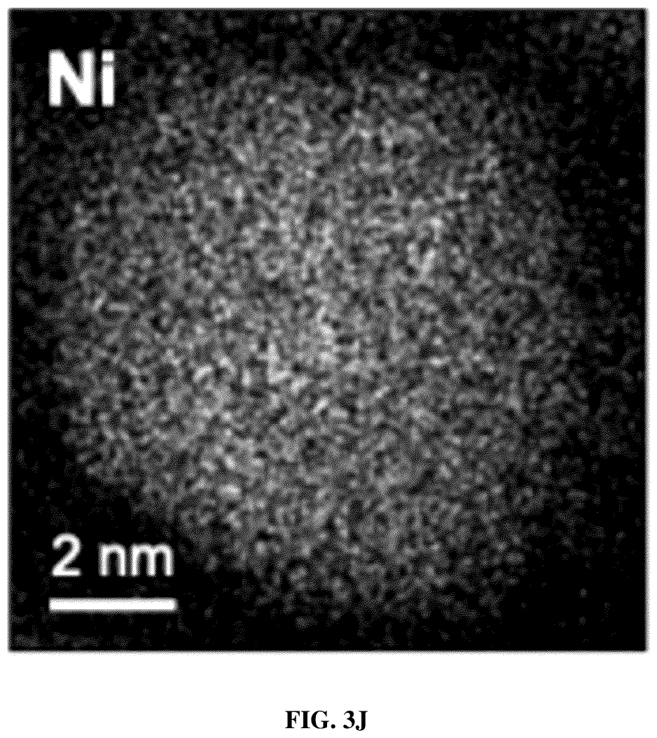

FIGS. 3A, 3B, 3C, 3D, 3E, 3F, 3G, 3H, 3I, and 3J are images showing the results of the atomic unit microstructure and chemical composition analysis of SFMMCCN after reduction treatment.

Referring to FIGS. 3A, 3B, 3C, 3D, 3E, 3F, 3G, 3H, 3I, and 3J, the analysis results show that nanoparticles are uniformly eluted from a matrix with a size of about 20 nm, and are firmly fixed at the same time.

According to the chemical composition analysis, the nanoparticles were confirmed to be composed of a Ni—Fe—Cu alloy.

### Experimental Example 3. Catalytic Activity Evaluation Analysis

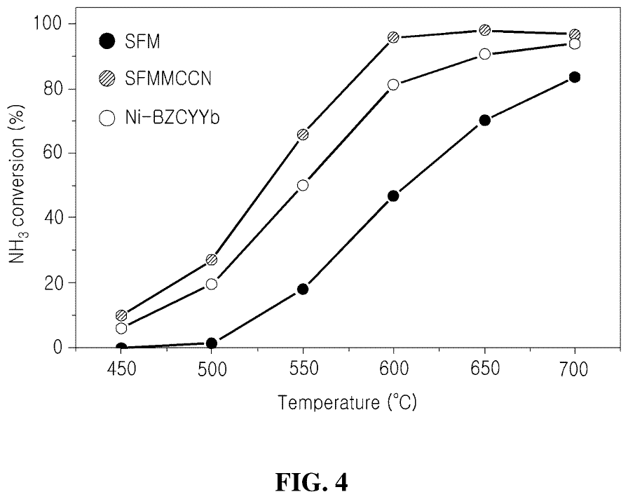

FIG. 4 is a graph showing the decomposition rate of Ni—BZCYYb, a fuel electrode material, low-entropy SFM, and high-entropy material SFMMCCN for ammonia.

Measurements were performed after reduction at 700° C. for 2 hours for all samples.

Referring to FIG. 4, it is possible to confirm that the SFMMCCN sample with dissolved Ni—Fe—Cu nanoparticles showed the highest performance.

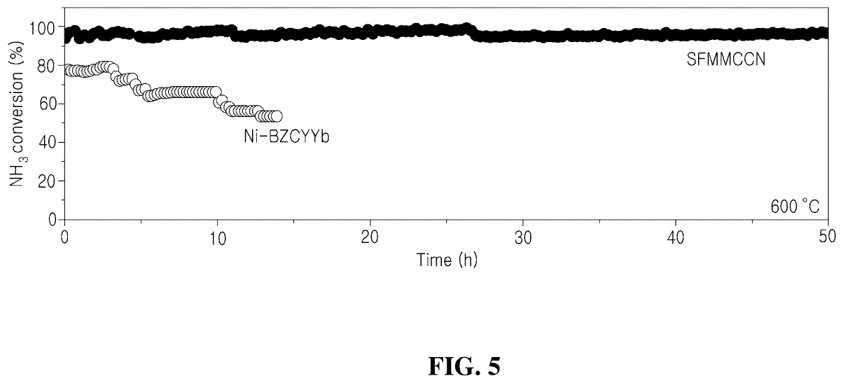

FIG. 5 is a graph showing the results of the catalytic stability evaluation of a Ni—BZCYYb material and an SFMMCCN material.

Referring to FIG. 5, it was confirmed that SFMMCC had a high ammonia decomposition rate and stability for 50 hours, but the existing fuel electrode material, Ni—BZCYYb, showed a continuous decrease in catalytic performance.

### Experimental Example 4. Unit Cell Microstructural Analysis

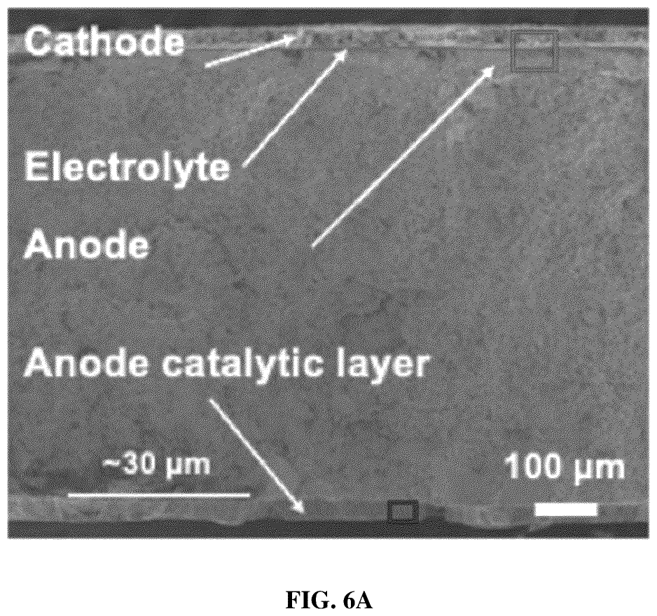

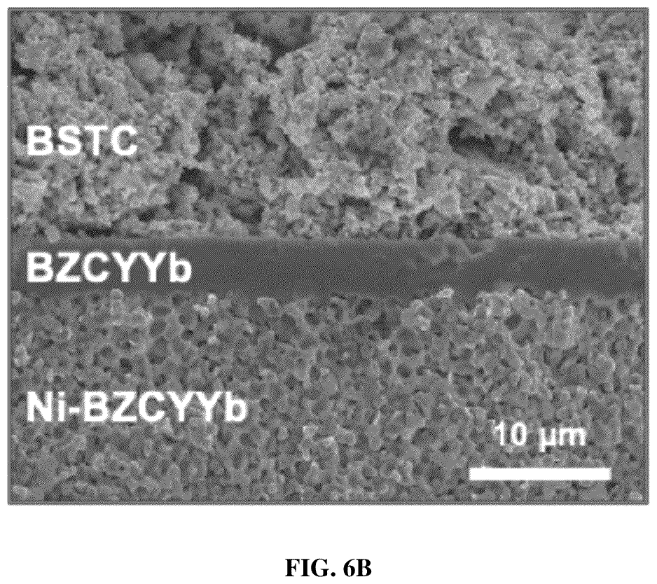

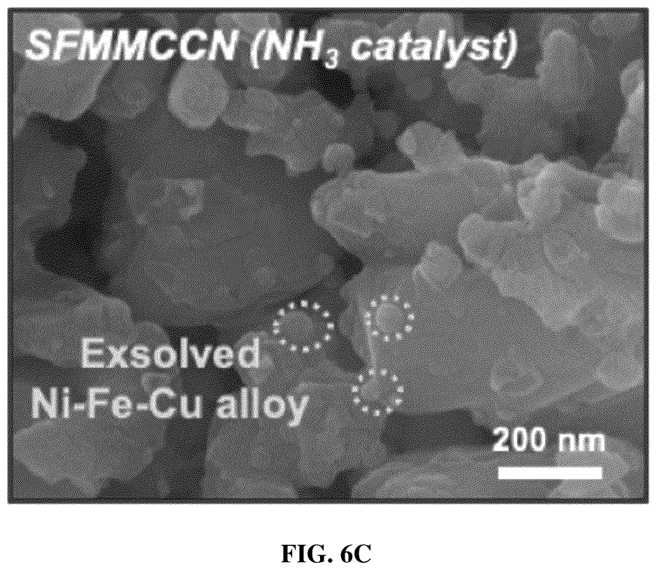

FIGS. 6A, 6B, and 6C are images showing the results of the cross-sectional microstructure analysis of NH₃—PCFC to which a catalyst layer is applied according to an embodiment of the disclosure.

Referring to FIGS. 6A, 6B, and 6C, it is possible to confirm that the catalyst layer is uniformly laminated with a thickness of about 30 μm and the alloy eluted on the surface of the catalyst layer after the electrochemical evaluation is uniformly distributed without agglomeration.

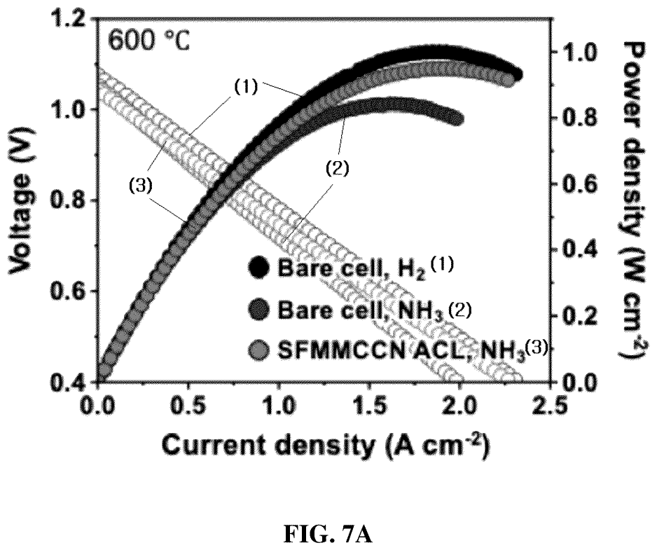

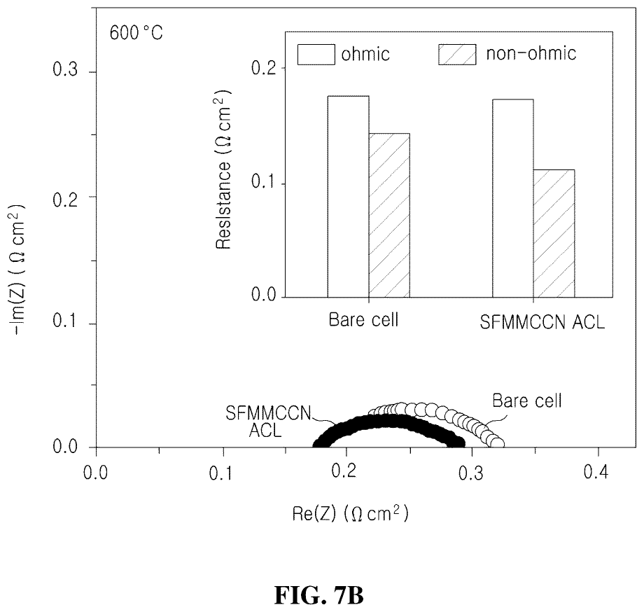

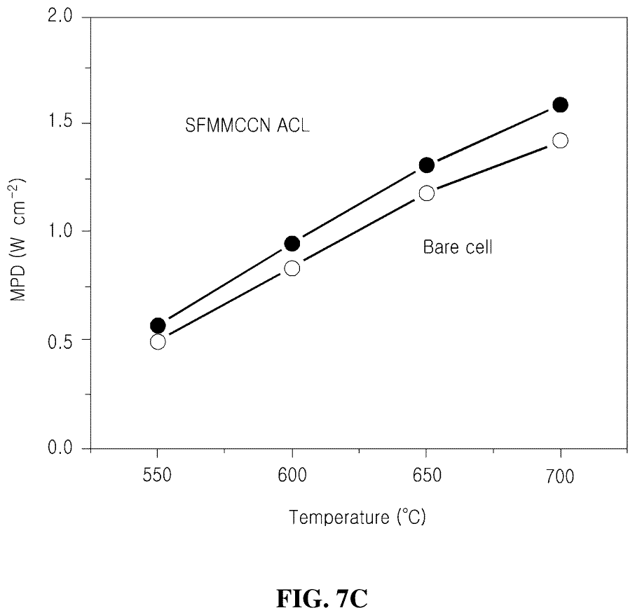

FIGS. 7A, 7B, and 7C are graphs showing the electrochemical performance results for a unit cell (SFMMCCN ACL) to which a catalyst layer is applied according to an embodiment of the disclosure and a unit cell (Bare cell) to which the catalyst layer is not applied.

Referring to FIGS. 7A, 7B, and 7C, it is possible to confirm that when the catalyst layer is applied, high power density is achieved with low ohmic and electrode resistance at 600° C., and
in addition, it is possible to confirm that the unit cell introducing the catalyst layer shows high performance in the temperature range from 700° C. to 550° C.

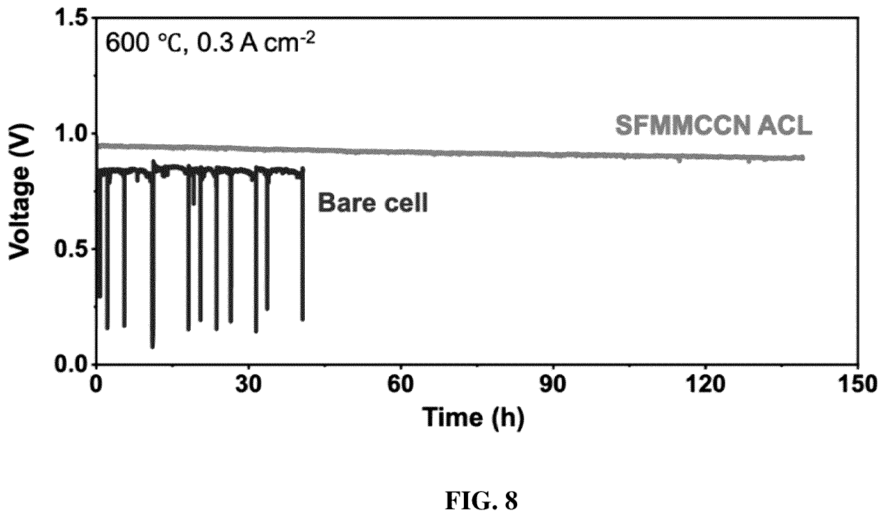

FIG. 8 is a graph showing the stability results for a unit cell (SFMMCCN ACL) to which a catalyst layer according to an embodiment of the disclosure is applied and a unit cell (Bare cell) to which the catalyst layer is not applied.

Referring to FIG. 8, it was confirmed that the unit cell without a catalyst layer showed stable performance without a sudden performance degradation in an ammonia fuel atmosphere when a catalyst layer was applied, but the unit cell without a catalyst layer showed unstable performance.

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

1. A high-entropy perovskite oxide-based catalyst material, comprising:
a perovskite oxide comprising strontium (Sr), iron (Fe), molybdenum (Mo), manganese (Mn), chromium (Cr), copper (Cu), and nickel (Ni),
wherein nano alloy particles are eluted onto a surface of the perovskite oxide in a reducing atmosphere.

2. The high-entropy perovskite oxide-based catalyst material of claim 1, wherein the perovskite oxide is represented by chemical formula 1: 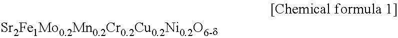
wherein, in chemical formula 1, the δ has a value in a range of 0 to 0.5.

3. The high-entropy perovskite oxide-based catalyst material of claim 1, wherein the nano alloy particles are nano particles having an average diameter size in a range of 10 nm to 30 nm.

4. The high-entropy perovskite oxide-based catalyst material of claim 1, wherein the nano alloy particles are a ternary alloy composed of Ni, Fe, and Cu.

5. The high-entropy perovskite oxide-based catalyst material of claim 1, wherein the nano alloy particles, while being eluted onto the surface of the perovskite oxide and fixed on the surface of the perovskite oxide, are uniformly distributed over the surface of the perovskite oxide.

6. A method for producing high-entropy perovskite oxide-based catalyst material, comprising:
providing a mixed solution comprising a high-entropy perovskite precursor;
forming a uniform sol with the mixed solution;
drying the uniform sol to form a gel;
pre-calcining the gel to form ash; and
calcining the ash to obtain a high-entropy perovskite powder.

7. The method of claim 6, wherein in the providing of the mixed solution, the high-entropy perovskite precursor comprises a strontium (Sr) source, an iron (Fe) source, a molybdenum (Mo) source, a manganese (Mn) source, a chromium (Cr) source, a copper (Cu) source, and a nickel (Ni) source.

8. The method of claim 6, wherein the forming of the uniform sol comprises:
adding citric acid and ethylenediaminetetraacetic acid (EDTA) to the mixed solution; and
adjusting a pH value of the mixed solution to a range of approximately 7 to 9 with an ammonia aqueous solution.

9. The method of claim 6, wherein the forming of the gel is performed by drying the uniform sol at a temperature range of 80° C. to 100° C.

10. The method of claim 6, wherein in the pre-calcining, heating is performed in a temperature range of 300° C. to 400° C.

11. The method of claim 6, wherein the calcining is performed in a temperature range of 1,000° C. to 1,100° C.

12. A direct ammonia proton conductive fuel cell (NH₃—PCFC), comprising:
a fuel electrode;
a catalyst layer disposed on the fuel electrode;
a proton conductive electrolyte layer disposed on the catalyst layer; and
an air electrode disposed on the proton conductive electrolyte layer,
wherein the catalyst layer comprises the high-entropy perovskite oxide-based catalyst material of claim 1.

13. The direct ammonia proton conductive fuel cell (NH₃—PCFC) of claim 12, wherein the fuel electrode is composed of a fuel electrode support and a functional layer, and comprises a composite of NiO and BaZr_{0.4}Ce_{0.4}Y_{0.1}Yb_{0.1}O_{3-δ} (BZCYYb) where the δ is a value in a range of 0 to 0.5).

14. The direct ammonia proton conductive fuel cell (NH3-PCFC) of claim 12, wherein the proton conductive electrolyte layer comprises BaZr_{0.4}Ce_{0.4}Y_{0.1}Yb_{0.1}O_{3-δ} (BZCYYb) where the δ is a value in a range of 0 to 0.5.
